(19) United States
(12) Patent Application Publication
(10) Pub. No.: US 2014/0054963 A1
(43) Pub. Date: Feb. 27, 2014

(54) ELECTRICAL POWER REGULATING AND MONITORING SYSTEMS AND OUTLET SYSTEMS THEREFOR

(71) Applicants: Rostislav Spitchka, Latham, NY (US); Jay Sherwood, Albany, NY (US); Sajid Mahmood, Clifton Park, NY (US)

(72) Inventors: Rostislav Spitchka, Latham, NY (US); Jay Sherwood, Albany, NY (US); Sajid Mahmood, Clifton Park, NY (US)

(73) Assignee: The Research Foundation for the State University of New York, Albany, NY (US)

(21) Appl. No.: 14/112,604

(22) PCT Filed: Apr. 20, 2012
(86) PCT No.: PCT/US12/34450

§ 371 Date: Oct. 18, 2013

Related U.S. Application Data
(60) Provisional application No. 61/477,394, filed on Apr. 20, 2011.

(51) Int. Cl. H02J 3/00; G08C 15/00

(52) U.S. Cl. CPC H02J 3/00; G08C 15/00
USPC 307/40

(57) ABSTRACT

A system includes a plurality of outlet systems receivable in respective electrical boxes in a building and connected via electrical wires to an electric power supply. The plurality of outlet systems include at least one electrical receptacle connectable to an electrical appliance, a computing unit operable to monitor the electrical appliance, a switch for interrupting electrical power to the electrical appliance in response to the computing unit. The at least one electrical receptacle, the computing unit, and the switch are configured to be receivable within and connectable to the electrical box and covered by a cover plate having at least one opening for accessing the at least one electrical receptacle. A network device is operable for communicating with the plurality of outlet systems and for communicating with a global communications network.

### CROSS-REFERENCE TO RELATED APPLICATION

This application is a 371 national stage filing of PCT International Application No. PCT/US2012/034450 filed on 20 Apr. 2012, and published in English on Oct. 26, 2012, as WO/2012/145627, which claims the benefit of U.S. Provisional Application No. 61/477,394, filed Apr. 20, 2011, entitled “Electrical Power Regulating And Monitoring Systems And Outlet Systems Therefor, which applications are hereby incorporated herein by reference in their entirety.

### FIELD OF THE INVENTION

The present invention relates generally to electrical outlets, and more specifically, to electrical power regulating and monitoring systems.

### BACKGROUND OF THE INVENTION

All of these standby power in America amounts to 64 million MWh, or 5% of energy usage in the United States; the equivalent of 18 power stations running full-time.

U.S. Patent Application Publication No. 2010/0305773 by Cohen discloses apparatus, systems and methods system for reducing power consumption in a network including electrical appliances connected via electrical outlets to an electricity supplier and/or a system managing power consumption. The apparatus may be integrated with a plug and/or a socket into a unit. The unit may comprise the apparatus, at least one socket (a female connector), and at least one plug (a male connector).

Therefore, there is a need for further electrical power regulating and monitoring systems.

### SUMMARY OF THE INVENTION

In a first aspect, the present invention provides an electrical power reducing and monitoring system connectable to an electrical power supply in a building. The system includes a plurality of outlet systems receivable in respective electrical boxes in the building and connected via electrical wires to the electric power supply. The plurality of outlet systems include at least one electrical receptacle connectable to an electrical appliance, a computing unit operable to monitor the electrical appliance connected to the at least one electrical receptacle, a switch for interrupting electrical power to the electrical appliance in response to the computing unit, a housing for containing and electrically connectable to the at least one electrical receptacle, the computing unit, and the switch, and wherein the housing is receivable within the electrical box and electrically connectable to the electrical wires in the electrical box and coverable by a cover plate having at least one opening for accessing the at least one electrical receptacle. A network device is connectable to the electrical power supply in the building and operable for communicating locally with the plurality of outlet systems and for remotely communicating with a global communications network.

In a second aspect, the present invention provides an electrical outlet system receivable in an electrical box in a building and operably electrically connected via electrical wires to an electric power supply. The outlet system includes at least one electrical receptacle connectable to an electrical appliance; a computing unit operable to monitor the electrical appliance connected to the at least one electrical receptacle, a switch for interrupting electrical power to the electrical appliance in response to the computing unit, a housing for containing and electrically connected to the at least one electrical receptacle, the computing unit, and the switch, and wherein the housing is receivable within the electrical box and electrically connectable to the electrical wires in the electrical box and coverable by a cover plate having at least one opening for accessing the at least one electrical receptacle.

In a third aspect, the present invention provides a computerized method for use in monitoring and reducing the use of electrical power. The method includes monitoring operation of an electrical device connected to an outlet system disposed in an electrical box in a building and operably electrically connected to an electrical power supply, and disconnecting, in the electrical box, the electrical power supply to the electrical device in response to the electrical appliance being disposed in a standby mode.

In a fourth aspect, the present invention provides a computerized a computerized method for use in monitoring and reducing the use of electrical power. The method includes monitoring operation of a plurality of electrical devices connected to a plurality of outlet systems disposed in a respective plurality of electrical boxes disposed in a building, and forwarding data regarding the monitoring from the plurality of outlet systems to a local network device operable for communicating with a global communications network.

In a fifth aspect, the present invention provides a computerized method for use in monitoring and reducing the use of electrical power. The method includes receiving data via a first local communications link regarding a plurality of outlet systems connected to respective electrical appliances disposed in a building, and forwarding information regarding the data via a second communications link for display on a display for a customer.

In a sixth aspect, the present invention provides a system for use in monitoring and reducing the use of electrical power. The system includes a computing unit for receiving data via a first communication link regarding a plurality of outlet systems connected to respective electrical appliances disposed in a building, and the computing unit operable for forwarding the data via a second communications link for display on a display observable by a customer.

In a seventh aspect, the present invention provides at least one program storage device readable by a machine, tangibly embodying at least one program of instructions executable by the machine to perform a method for use in monitoring and reducing the use of electrical power. The method includes receiving data via a first communication link regarding a plurality of outlet systems connected to respective electrical appliances disposed in a building, and forwarding the data via a second communications link for display on a display observable by a customer.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a diagrammatic illustration of one embodiment of an electrical power regulating and monitoring system in accordance with an aspect of the present invention;

FIG. 2 is a perspective view of one embodiment of an outlet system disposed in buildings such as homes or businesses of FIG. 1 in accordance with an aspect of the present invention;

FIG. 3 is a block diagram of the outlet system of FIG. 2;

FIG. 4 is graph of a normal distribution histogram for an electrical device monitored in accordance with an aspect of the present invention;

FIG. 5 is a block diagram of alternative embodiment of an outlet system in accordance with the present invention;

FIG. 6 is a block diagram of alternative embodiment of an outlet system in accordance with the present invention;

FIG. 7 is a block diagram of a network device in accordance with an aspect of the present invention connected to an outlet system of FIG. 2;

FIG. 8 is a block diagram of the network device of FIG. 7;

FIG. 9 is a block diagram of alternative embodiment of a network device in accordance with the present invention; and

FIG. 10 is a screen display generated upon accessing the remote interactive service of FIG. 1.

### DETAILED DESCRIPTION OF THE INVENTION

The present invention is generally directed to electrical power regulating and monitoring systems and components therefore that provide an affordable, multi-tiered approach to mitigating power leakage and decreasing the customer's electric consumption. The systems offer a localized smart grid that saves customers money through a power leakage reduction technology. The systems also provide the customer the ability to drill down and analyze the electric consumption data on a per outlet basis. The electrical power regulating and monitoring system generally comprises hardware components that are easily installed in buildings such as homes and/or businesses, and an online service that work together to provide energy savings.

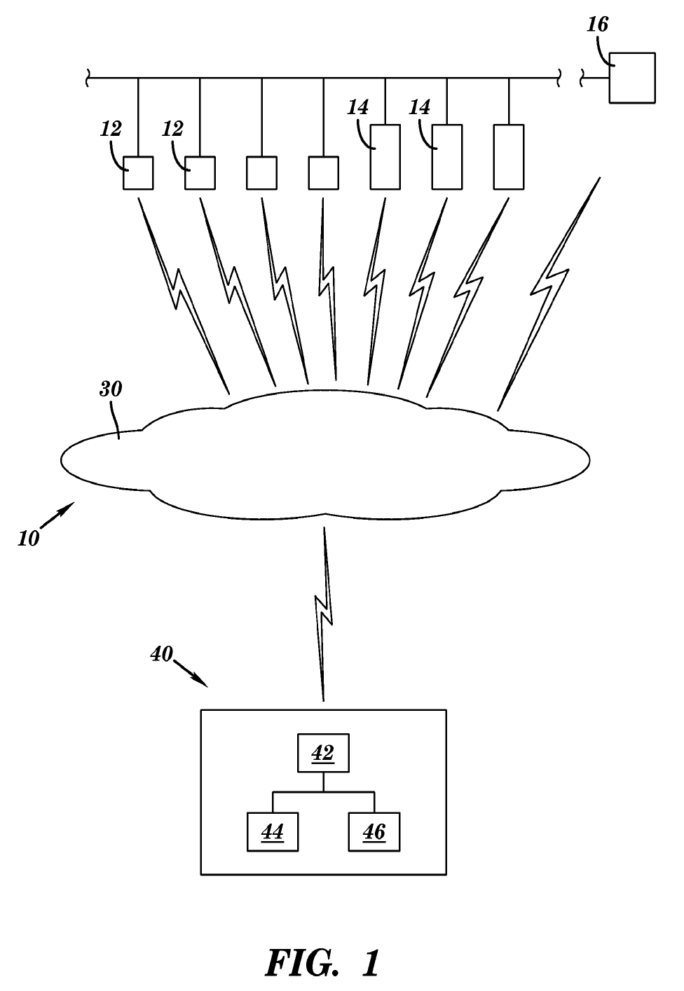

FIG. 1 illustrates one embodiment of an electrical electric power reducing and monitoring system 10 in accordance with an aspect of the present invention. In this exemplary embodiment, system 10 may operably connect a plurality of homes 12 and a plurality of businesses 14 that are supplied with electrical power, for example, from an electrical power plant 16, to a remote interactive service 40 via a communications network 30 such as a global communications network, e.g., the Internet. The system may further be configured to operably connect a plurality of homes and a plurality of businesses that are supplied by different electrical power plants. While the system is described in connection with an electrical power supplier, it will be appreciated that the systems are suitable for incorporation with other electrical generating systems such as homes and businesses having stand-alone electrical solar power systems.

As described in greater detail below, the system may include a plurality of outlet systems that are installed in the homes or businesses to mitigate power leakage by cutting off power to plugged-in electrical devices once the electrical devices enters a standby state. An outlet system network device may plug into an outlet in the home or business to gather information from the various installed outlets via power line networking technology, and broadcasts it via, for example, a Wi-Fi network to the remote interactive service. The remote interactive service allows home owners the ability to monitor past power usage, set timers to automatically shut off the outlet systems, receive notifications of unusual power consumption, and receive recommendations for possible replacement electrical appliances that would generate a positive return on investment. With controls, permissions and/or customizability, businesses can integrate power monitoring into a manager's work flow, ensuring businesses spend as little money as possible on power in a truly automated fashion.

### Outlet System

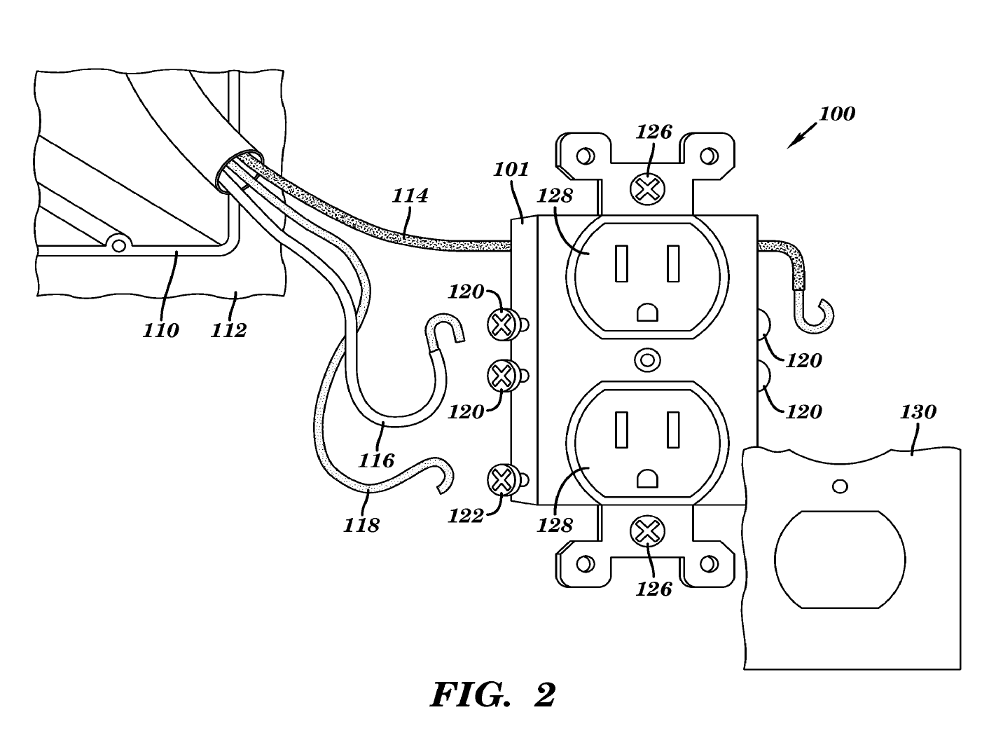

As shown in FIG. 2, an outlet system 100 in accordance with an aspect of the present invention is receivable in a respective electrical box 110 secured in a wall 112 of home 12 (FIG. 1) or business 14 (FIG. 1) and operably electrically connected for example via wires 114, 116, and 118 to an electric power supply 16 (FIG. 1). Outlet system 100 may include a housing 101 having a plurality of terminal screws 120 and a grounding screw 122 connectable to the wires, a pair of retaining screws 126 for securing the outlet system to the electrical box, and at least one electrical receptacle 128 connectable to an electrical appliance (not shown in FIG. 1). Outlet system 100 may be installed in new homes as well as be replacements for conventional electrical outlets or electrical receptacles installed in homes and businesses. Outlet 100 may be suitably covered with a standard cover 130 having openings therein for accessing the electrical receptacle or a customizable cover having additional ports or components as described below.

In accordance with an aspect of the present invention, outlet system 100 may be configured to inhibit or prevent power leakage or “vampire draw” by automatically cutting off power to an electrical appliance as soon as the electrical appliance goes into a standby mode. For example, outlet system 100 may mitigate the power leakage by cutting off power to the device altogether, as if the device is completely off. The power savings desirably add up across many devices in a home or a facility.

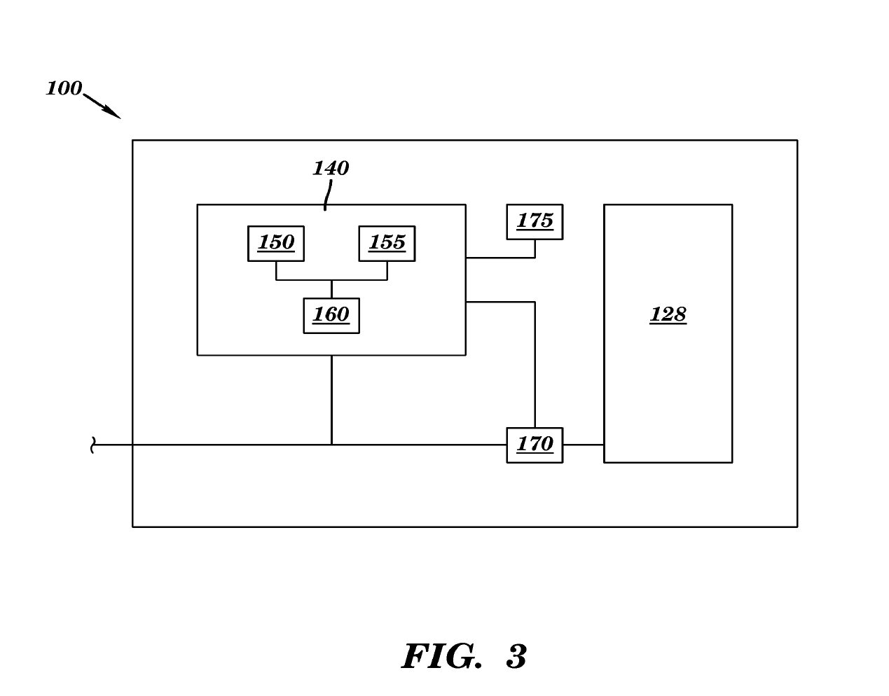

As shown in FIG. 3, in one embodiment outlet system 100 may include in housing 101, receptacles 128 and may further include a computing unit 140, which may include a logic chip, microcontroller, or processor 150, a memory 155 operably connected to the processor, and one or more input/output devices 160.

Processor 150 may be configured or programmed to control electrical power flow using both internal information within the processor, and external information communicated to the processor.

Input/output devices 160 may include communication means such as a transceiver used to communicate with other such outlets systems as well as an external and complimentary networking device as described below. For example, the transceiver may allow for communicating information regarding the electrical appliance from the processor to a remote interactive service. The processor or transceiver may also assign a specific address to a particular outlet system, as well as specific addresses to individual receptacles within an outlet system.

A switch 170 may be operably electrically connected to interrupt the supply of electrical power to the electrical appliance plugged into receptacle 128. For example, switch 170 may be an electronic switch or a mechanical switch (or a combination of the two), which is incorporated into the outlet system and is controlled by the processor to turn both electricity flow on or off through a specific outlet system or receptacle. Switch 170 may also be operably configured to provide a manual user override switch to override the automatic switching features controlled by the processor. Where a manual override switch is provided, a manual switch 175 may be provided on the face of the outlet system. A suitable cover plate may include an opening for accessing the manual override switch. It will be appreciated that the manual override switch may be a button or other suitable device and include a light such as an LED light to indicate that the manual feature is either on or off.

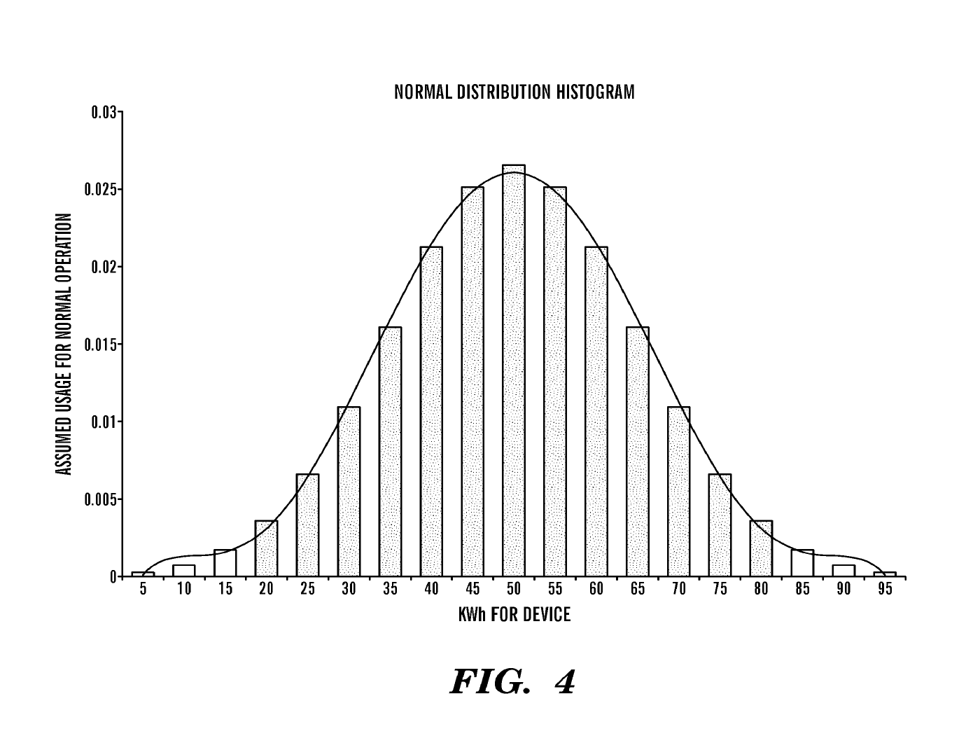

The processor may employ a standard distribution and time series mode models for power leakage reduction. In addition, input/output devices 160 may also include a sensor such as a current and/or voltage sensor. For example, a normal distribution model, such as shown in FIG. 4, is utilized when a device is first plugged in to the outlet system. When the device is on and operating, the processor uses data inputs from the sensor to calculate the mean (average) electrical usage of the device while in operation. Using the same data, a standard deviation is calculated by the processor using the variance of data input from the sensor. Using the mean and the standard deviation provided for the device, a normal distribution model is constructed by the processor using the following equation

$$f ( x ) = \frac{1}{\sqrt{2 {πσ}^{2}}} {e}^{\frac{- {( x - μ )}^{2}}{2 {σ}^{2}}}$$

where μ is the mean, and σ is the standard deviation.

By using the model, the processor can be used to send instructions to shut off power to the outlet once the power usage exceeds a certain deviation from the mean (for example, more than two standard deviations from the mean). An example of this model constructed for a device with average usage of 55 kWh and standard deviation of 15 kWhs is attached. The processor may reset and recalculate at any number of intervals; in particular, when a new or different device is plugged in, or when the outlet is switched on or off internally or externally.

In operation, while the outlet system cuts off power when electrical appliances and devices are not using it, a user of the system may still want some devices to remain on, even in low-power modes. To accommodate this, the outlet system may include the manual override switch, which will toggle between a power conservation mode and an override mode. While it may seem counterproductive to disable the outlet systems' power conservation function, such a feature may encourage adoption of such outlet systems by providing a convenient, adaptable technology that is easy to use by a user. In addition, the processor may automatically return the outlet system to the power conservation mode after a fixed or user adjustable period of time.

In the case of a laptop computer, for example, if a customer plugs in his laptop charger into the outlet system, during the charging process the outlet system draws 44.28 watts of electricity. After the laptop has finished charging, there still is a continuous power leakage draw of 4.42 watts, even though the device is on standby. This power leakage occurs when electronic devices are switched to standby, but still continue to draw power. In the situation where a user is using the computer and wants to leave it on while stepping away from the computer, the user is able to place the outlet system in the override mode. Upon returning to use the computer, the user can switch back to the power conservation mode. In addition, in connection with a network device described below, the system in accordance with an aspect of the present invention may include software which is run on the laptop and which provides an icon on the display of the laptop that allows the user to control the override switch from the laptop itself, e.g., via wireless communication from the laptop to the network device and the network device controlling the specific outlet system. From the present description, it will be appreciated that other electrical appliances may be provided with easily accessible buttons on the electrical devices or appliances which when activated send a signal wirelessly or through the electrical system to the connected network device or to the outlet system.

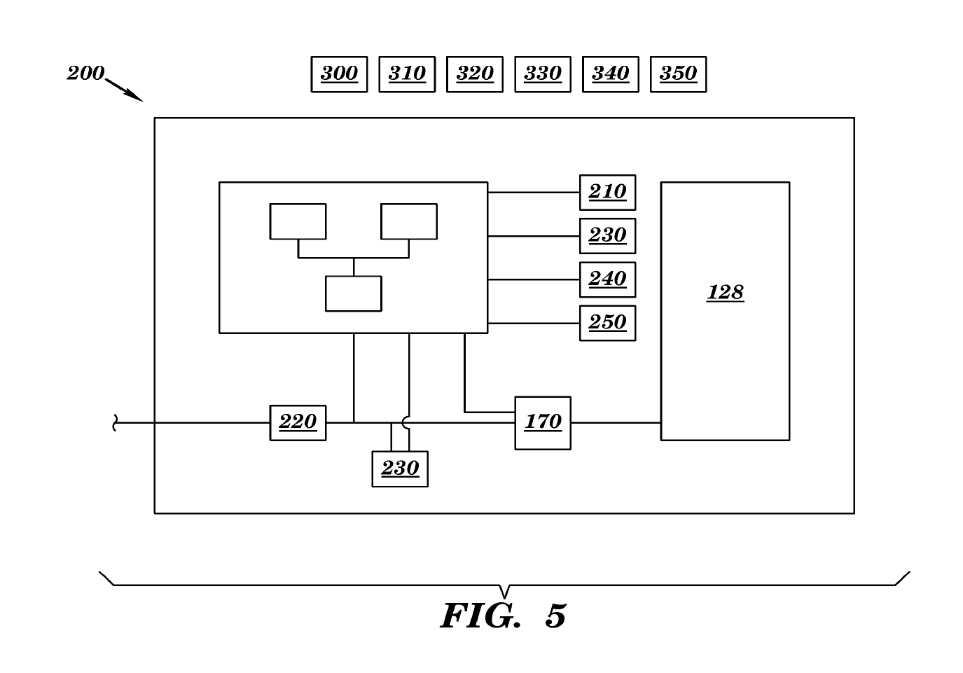

With reference to FIG. 5, in another embodiment of an outlet system 200, the various components may require a small supply of electrical power. The outlet system may utilize a small power source 210, separate from the electrical power running through the outlet, such as a battery, a capacitor, or a series or combination of the two to maintain some electrical charge within the outlet to power the system components. The small power source may be recharged using the main power supply running through the outlet system, and may employ a buffer in the form of an adapter or other such device to reduce the amount of electrical current it is exposed to. The smaller power source may be sufficiently charged to allow for activation of the system even in the event of power failure and to power plugged in apparatuses if such scenarios occur.

Outlet system 200 may also include a fuse or a circuit breaker 220 suitably connected to protect the outlet system and/or the electrical appliance from becoming overloaded and failing, similar to GFI (Ground Fault Interrupter) outlet. Outlet system 200 may also include a heat dissipation system, such as a strip of copper or aluminum, or a fan 210 to dissipate heat generated by the outlet system and other components in the outlet system.

In another aspect of the present invention, optional components in outlet system 20 may include an electronic port 230, such as a USB port, a FireWire port, Thunderbolt port, or proprietary port. This port could be used to charge devices, such as USB powered devices.

Outlet system 200 may also include a port 240 that may be used to allow expandability to the outlet system through peripheral modules and peripheral devices. Such peripheral modules and devices may include thermometers 300 or other temperature-gauging devices for reporting back to a central thermostat or for automatically adjusting the temperature in the room containing the outlet system, motion detector devices 310, smoke detectors 320, carbon monoxide detectors 330, built-in speaker or speakers 340 for radio transmissions, audio messages across the network, alarms, reporting on status of the outlet system, and reporting on the electrical appliance or device plugged into in the outlet system, and a display 350 such as an LCD light or LCD panel, or LED light or LED panel, to expressly report messages, status of device, status of the system, status of the appliances plugged in and other messages. Outlet system 200 may also have a built-in Ethernet port 250 allowing for a power line Ethernet network to be established within the home. The peripheral modules or devices may be connected to the front of the outlet system outside the electrical box (e.g., external) or may be connected and disposed in the electrical box (e.g., internal).

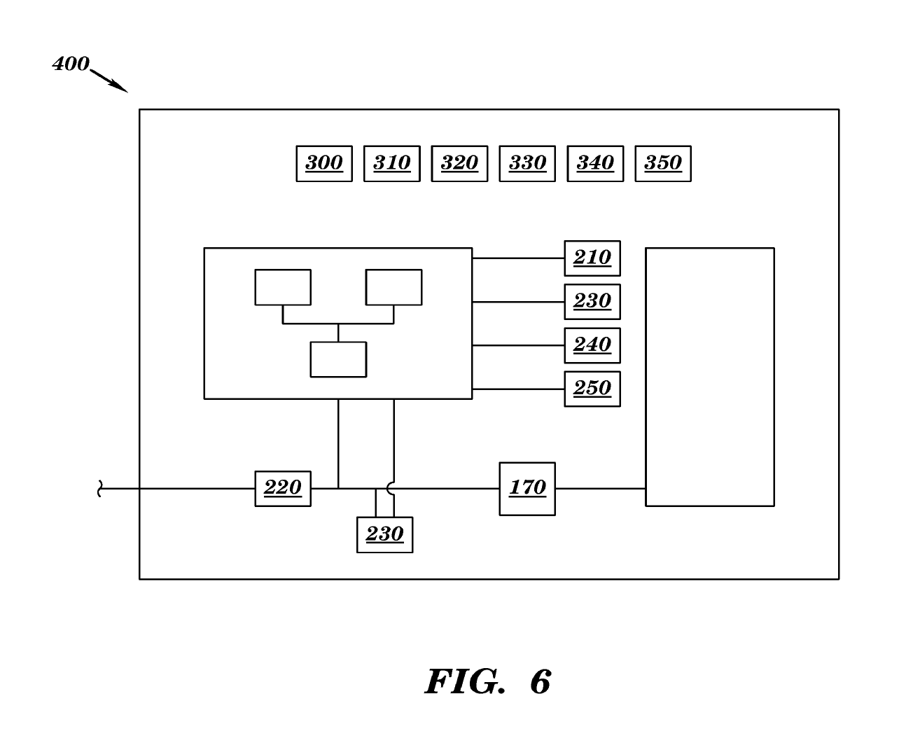

With reference to FIG. 6, in place of peripheral external modules and devices, some of the modules and peripheral devices, and their functions may be built into an outlet system 400. As described in below, the peripheral devices may take advantage of the networking features of the outlet systems 100 and 200, and/or system 10.

In addition, the various outlet systems may have power inversion functions or an option, to power computers and other electronics in lieu of a separate “power brick” or power inverted to change AC to DC. The outlet may have compatibility with authentication chips. The outlet systems may have all possible kinds of wireless communications technologies built in, including Wi-Fi, radio, cellular data, WiMAX, or any other sort of IEEE 802 specification.

The outlet systems may also contain power line networking technology, which, in conjunction with a network device and a remote interactive service, may provide a customer with up to another 1-5% energy conservation beyond the 5% that is saved by solely mitigating power leakage.

In addition, the outlet systems may have different versions with varying frequencies, designs, sockets, voltages etc, to account for different standards used in different countries and regions. Desirably, the various components of the outlet system operably fit into an electrical box such as a standard electrical box. From the present description, it will be appreciated that the outlet system of the present invention provides an unobtrusive outlet that mitigates power consumption when devices are not in use. The outlet system may employ customizable or decorated face plates.

In another aspect of the present invention, the outlet system, and its components, may be configured to be plugged into a conventional electrical outlet in a home or business and can be used to create other electrical devices such as power strips, surge protectors, or other external devices allowing further expandability and a larger selection of outlets.

Further means for monitoring the electrical usage of an appliance is disclosed in U.S. Patent Application Publication No. 2010/0305773 by Cohen, the entire subject matter of which is incorporated herein by reference. For example, the means for monitoring the electrical usage of an appliance may include detecting the statuses of electrical appliance by analyzing its signature, as received by a comparison of the returning signal to the original electric signal. A processing unit may perform an analysis process for determination of the appliance status indications. Possible embodiments of the analysis may include the following techniques: (i) comparing the impedance of electrical appliance when it is ON and when it is OFF to a reference measurement of the impedance when the electrical outlet is disconnected on its appliance side, to determine whether electrical appliance is connected or not; (ii) analysis of the electrical parameters such as the power consumption (real and imaginary power), the current and the voltage during the different states of electrical the appliance to determine appliance status such as whether the electrical appliance is connected, the appliance type and the appliance operational stage; (iii) frequency domain pattern recognition algorithms may be employed to determine the appliance status indications, e.g. use of spectral density of the current signal as a signature of an appliance at a certain operational stage; (iv) time-domain analysis of the electrical parameters such as the voltage and current measurements (including for example measuring the phase shift between the current and the voltage) during the different states of the electrical appliance. Time-domain and/or frequency domain pattern recognition algorithms may be employed to determine the appliance type or its stage.

In addition, the outlet system may allow for upgradable firmware, and the outlet system may include a LCD or LED screen.

### Outlet System Network Device

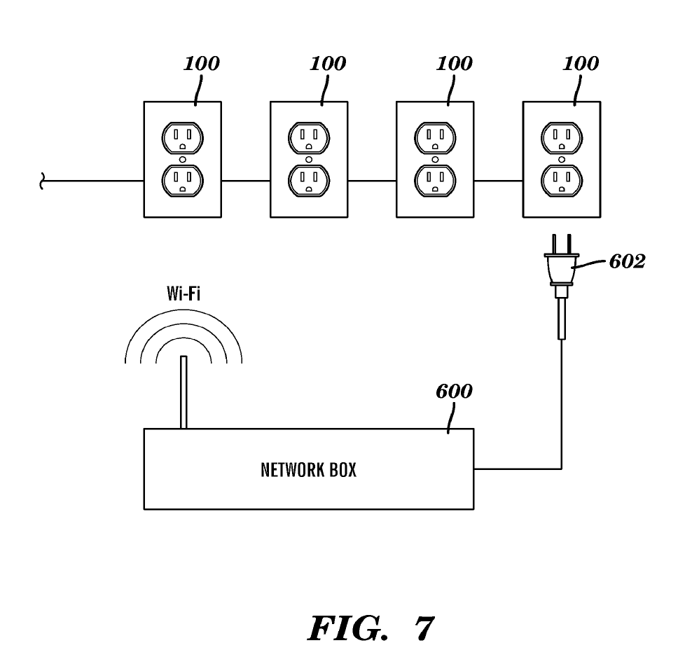

With reference to FIG. 7, while the outlet systems 100 of the present invention may stand on their own for automatically mitigating standby power consumption, an outlet system network device 600 may be provided which operably communicates with the outlet systems and communicates with remote interactive service 40 (FIG. 1) to allow consumers to monitor their electrical usage in detail.

Outlet system network device 600 may include a plug 602 and be plugged into any one of outlet systems 100 (FIG. 2) or outlet system 200 (FIG. 5) or 400 (FIG. 6), or into a standard outlet electrically connected in the home of business to receive data from the outlet systems and to transmit data provided by each outlet system 100 to remote interactive service 40 (FIG. 1). The outlet system network device may join a wireless network such as a Wi-Fi similar other wireless devices such as a laptop or smart phone. In other embodiments, the outlet system network device may include a standard wired connection from the network device to the global communication network.

For example, the outlet systems 100 and outlet system network device 600 may employ a power line networking technology, such as a HomePlug power line networking technology, to communicate with the outlet systems and gather vital statistics regarding energy consumption via the outlet systems in the building. Thus, the network device becomes a device on the Wi-Fi network, similar to a computer, and utilizes that connection to transmit data to remote interactive service 40 (FIG. 1) such as a secure Web Portal, where a consumer can log in and review their own power consumption and further data.

A benefit of powerline networking is that users can easily establish a network using a home's existing electrical wiring as the communication medium. There is no need to drill holes in walls or ceiling to route new wiring and, as a result, installation is quick, easy and relatively inexpensive.

With reference to FIG. 8, outlet system network device 600 may include, for example, a computing unit 605 such as a processor 610, data storage units or memory 620, and one or more input/output devices 630. The data storage units or memory 620 may be a hard drive, solid state drive, or secure digital card, that can store information provided by the outlets. Such information may include power consumption information in temporary holding before broadcasting the information such as in the event the user's home wireless network is down. Such stored information may also include appliances' electrical signatures so the network device can instantly recognize which electrical appliance or device is plugged in, and/or instructions such as timers to shut off the outlet systems. In addition, the outlet system network device may be implemented by employing cloud computing. In cloud computing, the outlet system network device may contain almost no software or data (perhaps a minimal operating system), serving as little more than a terminal for processes occurring on a network of remote computers.

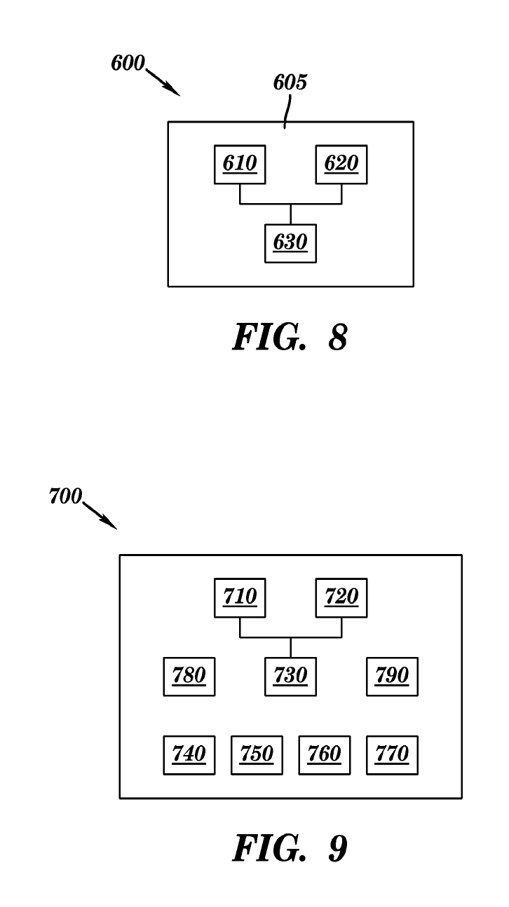

As shown in FIG. 9, in other embodiment, an outlet system network device 700 may also include a carbon monoxide detector 740 or similar device built-in. This would allow the user to not only get the benefits of a carbon monoxide detector if they do not already have one, but would also help net out the energy savings if they are able to replace an existing monoxide detector. The outlet system network device may also have a speaker 750 built-in for reproducing sounds. This can be used for reporting the status of the device, the status of the network, status of the carbon monoxide detector, playback of pre-recorded voice messages, or other valuable information.

The outlet system network device may also have a tactile switch 760 and light 770, such as an LED, that allows the user to visually check the status of the outlets/network device or test the carbon monoxide function if it is built-in.

The outlet system network device may also function as a repeater for the outlet system's reported information. If, for example, a customer wants the outlet system network device to take the information provided by the outlet system, and repeat it again to send it further down the power line, the box would be able to do so (e.g., via software and hardware).

The outlet system network device may also include a built-in router that replaces a customer's current router and gathers information from the same AC plug that powers the device. As a result, it would help with net energy savings.

The outlet system network device may also have an LCD screen 780 built in to display important information to the user, such as power consumption information, system status, or predefined text or video messages. The outlet system network device may have a USB/FireWire/Thunderbolt/etc. port 790 built-in to allow charging of devices that use those technologies, or allow for inputs and instructions via a keyboard or other external device.

### Remote Interactive Service

With reference again to FIG. 1, available online to users of the system, after the purchase of any number of outlets 100 and network device 600 (FIG. 7) is remote interactive service 40 such as an interactive website where the customer's power consumption information can be reviewed.

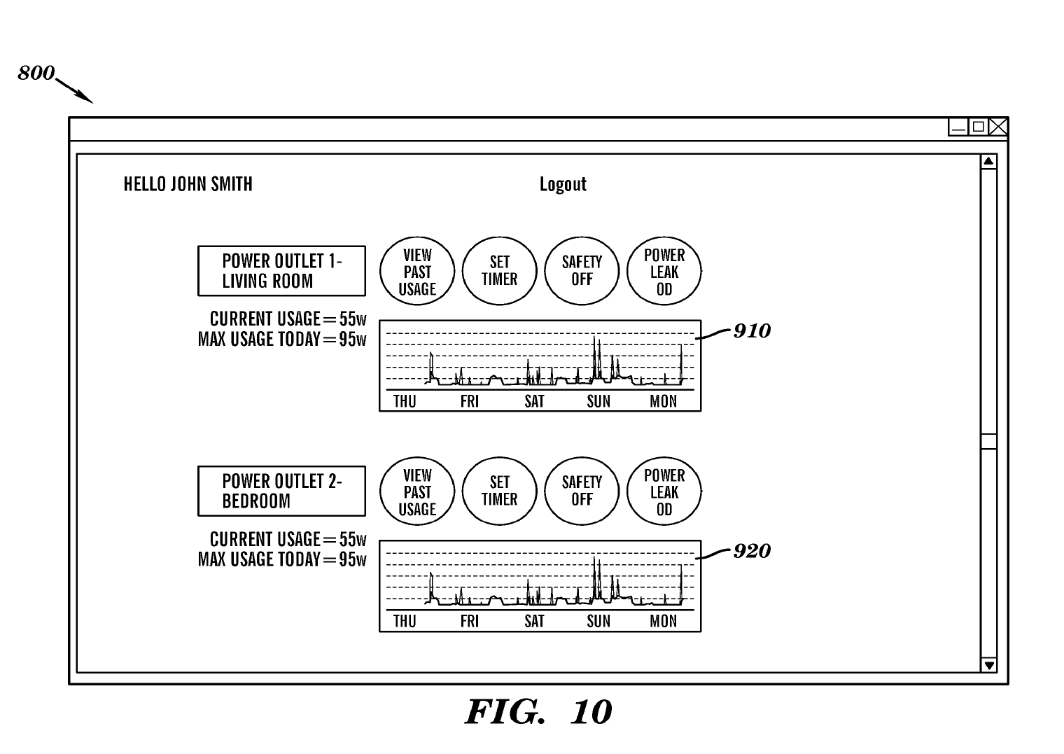

For example, as shown in FIG. 10, after logging in with a user name and password, a consumer is able to view a display 800 via an intuitive interface their recent power usage. By utilizing a drill down capability, the website may provide for displaying the user's power consumption information, outlet by outlet, allowing the user to develop a snapshot of their power consumption information. Graphs 910 and 920 may be provided to illustrate fluctuations of power consumption over various past time periods. A business may thus be able to mitigate outliers in their power system. For instance, if an employee brings in a space heater to heat their office, the website can be set up in a manner that would alert the system administrator of such power spikes. Also by monitoring what devices are plugged into an outlet, the consumer can see how much power a device, such as a refrigerator or television, is using.

The website may also allow consumers to remotely control their outlets to guard against needless usage of power. For instance, outlets located in a secure section of the building can be turned off. A timer system may also be part of the web interface, and would permit the turning of the outlets' power-saving features on and off on a timed basis. This may be a useful feature for companies that want all devices on from 9:00 am to 5:00 pm regardless of power consumption, but not during the evening.

With reference again to FIG. 1, remote interactive service 40 of the present invention may include, for example, one or more computing units 42, data storage units or memory 44, and one or more input/output devices 46, as is well known in the art. The central computing unit may be based, for instance, on a Sun workstation running a Unix operating system, or a personal computer running a Microsoft WINDOWS operating system. The computing unit desirably includes or has access to memory or data storage units, e.g., hard drive(s), compact disk(s), tape drive(s), etc., for storing various data which are accessed and used in monitoring the outlet systems.

As also described above, the communication network may include a local area network or a global communication network such as the Internet which comprises a vast number of computers and computer networks that are interconnected through communication links. The interconnected computers may exchange information using various services, such as electronic mail, and the World Wide Web (“WWW”). The WWW service allows receiving information or a web page from the interactive website.

Each resource (e.g., computer or Web page) of the WWW is uniquely identifiable by a Uniform Resource Locator (“URL”). To access information or view a specific Web page, for example, one computing unit specifies the URL for a second computing unit in a request (e.g., a HyperText Transfer Protocol (“HTTP”) request). For example, the interactive web service may be provided with a uniquely identifiable Uniform Resource Locator.

When the computing units of the electrical power regulating and monitoring systems, or online customer receives the information, it typically displays the information in a Web page using a browser. A browser is a special-purpose application program that effects the requesting of Web pages and the displaying of Web pages. The computing units 42 may typically use a browser such as Microsoft's INTERNET EXPLORER.

More particularly, web pages are typically defined using HyperText Markup Language (“HTML”). HTML provides a standard set of tags that define how a Web page is to be displayed. When the requested HTML document is received by a computing unit, the browser displays the Web page as defined by the HTML document. The HTML document contains various tags that control the displaying of text, graphics, controls, and other features.

The above-described computing environments and/or computing units are only offered as examples. The present invention can be incorporated and used with many types of computing units, computers, processors, nodes, systems, workstations and/or environments such as mobile devices, smart phones without departing from the spirit of the present invention. In addition, standardized data technologies such as but not limited to XML, HTML, MySQL, SQL, may be utilized and industry standard encryption protocols for security, such as SSL certificates and other encryption methods to ensure data viability and security. Further, standard Internet-based technologies and protocols (such as PHP and Java) may be employed.

Remote interactive service 40 collects the information that is published to it from the network devices as well as other sources such as partnering utility companies. Information that is gathered will be aggregated and displayed on the user interface. The service may also publish certain information at a user's request to participating utility companies, social media websites (Facebook, Twitter, et al.), and other sources. The service can choose different transmission technologies for the transmission of data, including changing the outlet's frequency it transmits on in the event it uses cellular technology or a Wi-Fi network that interferes with other equipment.

The service allows for the reporting and understanding of information gathered by the outlet systems and network devices. The service enables control of specific power outlets, setting of timers, alerts, seeing past usage history, setting of custom configuration, and of sponsored recommendations for new appliances. The service can also change how often system usage data gets reported to save energy. For example, only reporting usage statistics every hour instead of in real time.

Alerts can be created using SMS, MMS, phone numbers, e-mails, etc to alert the user of important events such as unusual power consumption patterns, high/low power consumption, or other preset criteria. A logic system can intelligently determine the user's usage patterns and appliance types. The service may then generate possible usage habit changes, e.g., if the service determines that a television runs all night, the service can recommend changing the sleep settings on the TV to turn off after a certain point in time as the user may be falling asleep with the TV on.

The service may be operably configured to also generate new sponsored recommendations for appliances or devices that would be more efficient. Some of this functionality may have to be setup by the user/installer, IE specifying the brand and model of the appliance that is plugged into a particular outlet.

The service may also provide a secure authentication system: i.e., turn an outlet to an ON state once correct credentials have been entered. Possible uses for this include airports, secure facilities, and public facilities.

The service can also be setup in conjunction with a billing system that would automatically toggle a particular outlet system to an ON state once a certain fee that is set by the owner of the system has been paid. Once the outlet systems are no longer paid for it would be switched to an OFF state by the service. Possible uses for this include: public places such as coffee shops, airports, electric vehicle charging stations, etc. Another example, if a user buys an hour of outlet service time through an airport, the user can enter credit card or other payment info into the website online so airport can charge the user for the outlet and the remote interactive service can automatically turn outlets on. Quotas can also be set in the system. A hotel for instance may set a quota of X amount of watts and automatically turn the outlet system off if an appliance that draws more than X amount of watts is plugged in. In a similar manner a maximum cap on the amount of kWh can also be set.

The remote interactive service may also have the ability to control attachments or peripherals that are plugged into the system. Attachments or peripherals that are built into the outlet systems can also be controlled.

As described above, recommendations for new appliance may be provided by the interactive website via an intuitive interface. For example, an old refrigerator plugged into “Break Room Outlet 2” on the “Fourth Floor” may be measured as taking up 500 KWh. As a result, the website may make a recommendation for a new, Energy Star-rated refrigerator that uses only 200 KWh. In addition, the consumer may be provided with calculations of how much their current refrigerator is costing them, how much they would save over time, and how long it would take for them to recoup the cost of the refrigerator in energy savings. Appliance companies and sponsors may be charged a fee to have their products recommended.

The web interface has an advanced customizability feature available to power users or programmers. This can be used for a variety of executive functions: from automatic energy reporting to energy utilities, to Oracle or SAP integration for executives and managers to routinely check power consumption information. This adds value to the product and provides the user with limitless customizability concerning reporting the robust sets of information the Green Fox Power System provides.

With more and more electrical devices being manufactured and sold with standby modes, the amount of standby power being consumed on a daily basis will likely increase. Use of the present invention desirably reduces this increased demand and waste.

From the present description, it will be appreciated that the network device may transmit data via a communications link, e.g., Wi-FI, to a consumer's computer. In this stand-alone configuration, suitable software may be employed on the consumer's computer to process the data and allow the consumer to control the various outlet systems. It will be further appreciated that the system may include the ability of the consumer to monitor the outlet systems directly from the consumer's computer and/or in combination with the website as described above.

As noted above, the present invention may be implemented using conventional models of computing where both data and software are fully contained on the outlet system, outlet system network device, and/or a consumer's computer. In another aspect, the present invention may be implemented by employing cloud computing. In cloud computing, the outlet system, outlet system network device, and/or a consumer's computer may contain almost no software or data (perhaps a minimal operating system and web browser only), serving as little more than a terminal or display terminal for processes occurring on a network of remote computers.

A1. An electrical power reducing and monitoring system connectable to an electrical power supply in a building, said system comprising: a plurality of outlet systems (100) receivable in respective electrical boxes in the building and connected via electrical wires to the electric power supply, said plurality of outlet systems comprising: at least one electrical receptacle (128) connectable to an electrical appliance; a computing unit (140) operable to monitor the electrical appliance connected to the at least one electrical receptacle; a switch (170) for interrupting electrical power to the electrical appliance in response to the computing unit; a housing (101) for containing and electrically connectable to said at least one electrical receptacle, said computing unit, and said switch; and wherein said housing is receivable within the electrical box and electrically connectable to the electrical wires in the electrical box and coverable by a cover plate having at least one opening for accessing said at least one electrical receptacle; and a network device (600) connectable to the electrical power supply in the building and operable for communicating locally with said plurality of outlet systems and for remotely communicating with a global communications network. A2. The system of claim A1 wherein the network device comprises a plug (602) operably electrically connectable to at least one of a standard outlet and one of said plurality of outlet systems which are connectable to the electrical power supply. A3. The system of claim A1 wherein said network device and said plurality of outlet systems are operable to communicate locally via the electrical power lines and said network device is operable to communicate wirelessly with the global communications network. A4. The system of claim A1 wherein said network device and said plurality of outlet systems are operable to communicate locally wirelessly and said network device is operable to communicate wirelessly with the global communications network. A5. The system of claim A1 wherein said network device is operable to forward information regarding data regarding the outlet systems for display on an electronic device for the user. A6. The system of claim A1 wherein said network device is operable to provide a website or webportal accessible by a user for review of at least one of their power consumption and other information in connection with the plurality of outlet systems. A7. The system of claim A1 wherein said system is operable in combination with a service for providing information to the user regarding upgrading the electrical appliance. A8. The system of claim A1 wherein said computing unit is operable to effect interruption of electrical power to the electrical appliance when said electrical appliance is in a standby state. A9. The system of claim A1 further comprising a user accessible override switch (170) for inhibiting said computing unit from effecting interruption of electrical power to the electrical appliance when said electrical appliance is in a standby state. A10. The system of claim A1 wherein said system is operable to allow use of the electrical outlet to power the electrical appliance based on payment by a user of one of the electrical outlet systems, and effect interruption of electrical power to the electrical appliance after at least one of a predetermined period of time and a predetermined usage of electrical power. A11. The system of claim A10 wherein the outlet systems is disposable in at least one of a secure facility, a public facility, an airport, a coffee shop, and an electric vehicle charging station. A12. The system of claim A1 wherein at least one of the outlet systems comprises a port (230) for powering DC powered electrical devices. A13. The system of claim A12 wherein said port comprises a USB port. A14. The system of claim A1 wherein at least one of the outlet systems further comprises an auxiliary device (300, 310, 320, 330, 340). A15. The system of claim A14 wherein the auxiliary device comprising at least one of a thermometer (300), a motion detector (310), a smoke detector (320), a carbon monoxide detector (330). A16. The system of claim A14 wherein the auxiliary device comprising at least one of a speaker (340) and an alarm. A17. The system of claim A1 wherein at least one of the outlet systems comprises a port (240) releasably connectable to an auxiliary device (300, 310, 320, 330, 340). A18. The system of claim A17 further comprising the auxiliary device releasably connectable to the port, and where in the auxiliary device comprises at least one of a thermometer (300), a motion detector (310), a smoke detector (320), and a carbon monoxide detector (330). A19. The system of claim A17 further comprising the auxiliary device releasably connectable to the port, and wherein the auxiliary device comprising at least one of a speaker (340) and an alarm. A20. The system of claim A1 wherein at least one of said outlet systems further comprising a display (350), said display at least one of attached to the cover and observable through the cover for displaying data regarding the electrical appliance. A21. The system of claim A1 wherein said electrical receptacle comprises a pair of contact openings and a ground opening. A22. The system of claim A1 wherein said plurality of outlet systems are installable in electrical boxes disposed in the walls of the building.

B1. An electrical outlet system (100) receivable in an electrical box in a building and operably electrically connected via electrical wires to an electric power supply, said outlet system comprising: at least one electrical receptacle (128) connectable to an electrical appliance; a computing unit (140) operable to monitor the electrical appliance connected to the at least one electrical receptacle; a switch (170) for interrupting electrical power to the electrical appliance in response to said computing unit; a housing (101) for containing and electrically connected to said at least one electrical receptacle, said computing unit, and said switch; and wherein said housing is receivable within the electrical box and electrically connectable to the electrical wires in the electrical box and coverable by a cover plate having at least one opening for accessing said at least one electrical receptacle. B2. The outlet system of claim B1 wherein the computing unit is operable to effect interruption of electrical power to the electrical appliance when said electrical appliance is in a standby state. B3. The outlet system of claim B1 further comprising a user accessible override switch (170) for inhibiting said computing unit from effecting interruption of electrical power to the electrical appliance when said electrical appliance is in a standby state. B4. The outlet system of claim B1 wherein said outlet system is operable to allow use of the electrical outlet to power the electrical appliance based on payment by a user of the electrical, and effect interruption of electrical power to the electrical appliance after at least one of a predetermined period of time and a predetermined usage of electrical power. B5. The outlet system of claim B1 wherein the outlet systems is disposed in at least one of a secure facility, a public facility, an airport, a coffee shop, and an electric vehicle charging station. B6. The outlet system of claim B1 further comprising a network device connectable to the electrical power supply in the building and operable for communicating locally with said outlet system and for remotely communicating with a global communications network. B7. The outlet system of claim B6 wherein said network device comprises an electrical plug for connecting to at least one of said outlet system and a conventional outlet connected to the electrical power supply. B8. The outlet system of claim B6 wherein said network device and said outlet system is operable to communicate locally via the electrical power lines and said network device is operable to communicate wirelessly with the global communications network. B9. The outlet system of claim B6 wherein said network device and said plurality of outlet systems are operable to communicate locally wirelessly and said network device is operable to communicate wirelessly with the global communications network. B10. The outlet system of claim B6 wherein said network device is operable to provide a website or webportal accessible by a user for review of at least one of their power consumption and other information in connection with the outlet system. B11. The outlet system of claim B1 wherein at least one of the outlet systems comprises a port (230) for powering DC powered electrical devices. B12. The outlet system of claim B11 wherein said port comprises a USB port. B13. The outlet system of claim B1 wherein at least one of the outlet systems further comprises an auxiliary device (300, 310, 320, 330, 340). B14. The outlet system of claim B13 wherein the auxiliary device comprising at least one of a thermometer (300), a motion detector (310), a smoke detector (320), and a carbon monoxide detector (330). B15. The outlet system of claim B13 wherein the auxiliary device comprising at least one of a speaker (340) and an alarm. B16. The outlet system of claim B1 wherein at least one of the outlet systems comprises a port (240) releasably connectable to an auxiliary device (300, 310, 320, 330, 340). B17. The outlet system of claim B16 further comprising the auxiliary device releasably connectable to the port, and where in the auxiliary device comprises at least one of a thermometer (300), a motion detector (310), a smoke detector (320), and a carbon monoxide detector (330). B18. The outlet system of claim B16 further comprising the auxiliary device releasably connectable to the port, and wherein the auxiliary device comprising at least one of a speaker (340) and an alarm. B19. The outlet system of claim B1 further comprising a display (350), said display at least one of attached to a cover and observable through the cover for displaying data regarding the electrical appliance. B20. The outlet system of claim B1 wherein the electrical receptacle comprises a pair of contact openings and a ground opening. B21. The outlet system of claim B1 wherein the electrical box comprises the electrical box disposed in a wall of the building.

C1. A computerized method for use in monitoring and reducing the use of electrical power, the method comprising: monitoring operation of an electrical device connected to an outlet system (100) disposed in an electrical box in a building and operably electrically connected to an electrical power supply; and disconnecting, in the electrical box, the electrical power supply to the electrical device in response to the electrical appliance being disposed in a standby mode.

D1. A computerized method for use in monitoring and reducing the use of electrical power, the method comprising: monitoring operation of a plurality of electrical devices connected to a plurality of outlet systems (100) disposed in a respective plurality of electrical boxes disposed in a building; and forwarding data regarding the monitoring from the plurality of outlet systems to a local network device (600) operable for communicating with a global communications network. D2. The computerized method of claim D1 wherein the network device comprises a plug (602) operably electrically connectable to at least one of a standard outlet and one of the plurality of outlet systems which are connectable to the electrical power supply. D3. The computerized method of claim D1 wherein the forwarding comprises forwarding data regarding the monitoring via electrical power lines to the network device. D4. The computerized method of claim D3 further comprising forwarding data from the network device wirelessly to the global communications network. D5. The computerized method of claim D1 further comprising forwarding information to the user regarding upgrading at least one of the appliances based on the monitoring operation of the plurality of electrical devices.

E1. A computerized method for use in monitoring and reducing the use of electrical power, the method comprising: receiving data via a first local communications link regarding a plurality of outlet systems connected to respective electrical appliances disposed in a building; and forwarding information regarding the data via a second communications link for display on a display for a customer. E2. The computerized method of claim E1 further comprising controlling at least some of the plurality of outlet systems by the customer via the second communications link. E3. The computerized method of claim E1 further comprising providing a recommendation for upgrading the electrical appliance. E4. The computerized method of claim E1 wherein the first communications link comprises electrical power lines. E5. The computerized method of claim E1 wherein the second communications link comprises a global communications network.

F1. A system for use in monitoring and reducing the use of electrical power, the system comprising: a computing unit for receiving data via a first communication link regarding a plurality of outlet systems connected to respective electrical appliances disposed in a building; and said computing unit operable for forwarding the data via a second communications link for display on a display observable by a customer. F2. The system of claim F1 wherein said computing unit comprises a network device, and said first communication link is operable via electrical wires disposed in the building. F3. The system of claim F1 wherein said second communication link comprises a global communications network. F4. The system of claim F1 wherein said computing unit comprises a network device, and said second communications link comprises a wireless communications link. F5. The system of claim F1 wherein said computing unit is operable for providing a recommendation for upgrading the electrical appliance.

G1. At least one program storage device readable by a machine, tangibly embodying at least one program of instructions executable by the machine to perform a method for use in monitoring and reducing the use of electrical power, the method comprising: receiving data via a first communication link regarding a plurality of outlet systems connected to respective electrical appliances disposed in a building; and forwarding the data via a second communications link for display on a display observable by a customer. G2. The at least one program storage device of claim G1 wherein the first communications link is operable via electrical wires disposed in the building. G3. The at least one program storage device of claim G1 wherein the second communications link comprises a global communications network. G4. The at least one program storage device of claim G1 wherein the computing unit comprises a network device, and the second communications link comprises a wireless communications link.

Thus, while various embodiments of the present invention have been illustrated and described, it will be appreciated to those skilled in the art that many changes and modifications may be made thereunto without departing from the spirit and scope of the invention.

1-63. (canceled)

64. An electrical outlet system receivable in an electrical box in a building and operably electrically connected via electrical wires to an electric power supply, said outlet system comprising:
at least one electrical receptacle connectable to an electrical appliance;
a computing unit operable to monitor the electrical appliance connected to the at least one electrical receptacle;
a switch for interrupting electrical power to the electrical appliance in response to said computing unit;
a housing for containing and electrically connected to said at least one electrical receptacle, said computing unit, and said switch; and
wherein said housing is receivable within the electrical box and electrically connectable to the electrical wires in the electrical box and coverable by a cover plate having at least one opening for accessing said at least one electrical receptacle.

65. The outlet system of claim 64 wherein the computing unit is operable to effect interruption of electrical power to the electrical appliance when said electrical appliance is in a standby state.

66. The outlet system of claim 64 wherein the computing unit is operable to effect interruption of electrical power to the electrical appliance based electrical usage of the electrical appliance.

67. The outlet system of claim 64 wherein the computing unit is operable to effect interruption of electrical power to the electrical appliance based on a deviation from a mean.

68. The outlet system of claim 64 further comprising a user accessible override switch for inhibiting said computing unit from effecting interruption of electrical power to the electrical appliance when said electrical appliance is in a standby state.

69. The outlet system of claim 64 further comprising a network device connectable to the electrical power supply in the building and operable for communicating locally with said outlet system and for remotely communicating with a global communications network.

70. The outlet system of claim 69 wherein said network device comprises an electrical plug for connecting to at least one of said outlet system and a conventional outlet connected to the electrical power supply.

71. The outlet system of claim 69 wherein said network device and said outlet system is at least one of a) operable to communicate locally via the electrical power lines and said network device is operable to communicate wirelessly with the global communications network, and b) operable to communicate locally wirelessly and said network device is operable to communicate wirelessly with the global communications network.

72. The outlet system of claim 69 wherein said network device is operable to forward information regarding data regarding the outlet system for display on an electronic device for a user.

73. The outlet system of claim 69 wherein said system is operable in combination with a service for providing information to a user regarding upgrading the electrical appliance.

74. The outlet system of claim 64 further comprising at least one of:
a) at least one of a thermometer, a motion detector, a smoke detector, a carbon monoxide detector, a speaker, an alarm, and a port for powering DC powered electrical devices; and
b) a port releasably connectable to at least one of a thermometer, a motion detector, a smoke detector, a carbon monoxide detector, a speaker, an alarm, and a DC powered electrical device.

75. The outlet system of claim 64 wherein said outlet system is operable to allow use of the electrical outlet to power the electrical appliance based on payment by a user of the outlet system, and effect interruption of electrical power to the electrical appliance after at least one of a predetermined period of time and a predetermined usage of electrical power.

76. The outlet system of claim 75 wherein the outlet systems is disposable in at least one of a secure facility, a public facility, an airport, a coffee shop, and an electric vehicle charging station.

77. The outlet system of claim 64 further comprising a display, said display at least one of attached to the cover and observable through the cover for displaying data regarding the electrical appliance.

78. The outlet system of claim 64 further comprising at least one of a) said electrical receptacle comprising a pair of contact openings and a ground opening, and b) said outlet systems being installable in electrical boxes disposed in a wall of a building.

79. A computerized method for use in monitoring and reducing the use of electrical power, the method comprising at least one of:
a) monitoring operation of an electrical appliance connected to an outlet system disposed in an electrical box in a building and operably electrically connected to an electrical power supply, and disconnecting, in the electrical box, the electrical power supply to the electrical appliance in response to the electrical appliance being disposed in a standby mode;
b) monitoring operation of a plurality of electrical appliances connected to a plurality of outlet systems disposed in a respective plurality of electrical boxes disposed in a building, and forwarding data regarding the monitoring from the plurality of outlet systems to a local network device operable for communicating with a global communications network; and
c) receiving data via a first local communications link regarding a plurality of outlet systems connected to respective electrical appliances disposed in a building, and forwarding information regarding the data via a second communications link for display on a display for a customer.

80. The computerized method of claim 79 further comprising forwarding information to a user regarding upgrading at least one of the appliances based on the monitoring operation of the plurality of electrical appliances.

81. The computerized method of claim 79 further comprising inhibiting interruption, in the electrical box, of the electrical power supply to the electrical appliance in response to the electrical appliance being disposed in a standby mode.

82. The computerized method of claim 79 further comprising allowing use of the electrical outlet to power the electrical appliance based on payment by a user of the outlet system, and effect interruption of electrical power to the electrical appliance after at least one of a predetermined period of time and a predetermined usage of electrical power.

83. The computerized method of claim 82 wherein the allowing comprises allowing use of the electrical outlet to power the electrical appliance disposable in at least one of a secure facility, a public facility, an airport, a coffee shop, and an electric vehicle charging station.

84. A system for use in monitoring and reducing the use of electrical power, the system comprising:
a network device for receiving data via a first communication link regarding a plurality of outlet systems connected to respective electrical appliances disposed in a building; and
said network device operable for forwarding the data via a second communications link for display on a display observable by a customer.

85. The system of claim 84 wherein said network device is operable for providing a recommendation for upgrading the electrical appliance.

86. A system receivable in an electrical box in a building and operably electrically connected via electrical wires to an electric power supply, said system comprising:
at least one electrical device connectable to an electrical appliance;
a computing unit operable to monitor the electrical appliance connected to the at least one electrical receptacle;
a switch for interrupting electrical power to the electrical appliance in response to said computing unit;
a housing for containing and electrically connected to said at least one electrical device, said computing unit, and said switch; and
wherein said housing is receivable within the electrical box and electrically connectable to the electrical wires in the electrical box and coverable by a cover plate having at least one opening for accessing said at least one electrical device.

87. The system of claim 86 further comprising a network device connectable to the electrical power supply in the building and operable for communicating locally with said system and for remotely communicating with a global communications network.

88. The system of claim 87 wherein said network device is operable to forward information regarding data regarding the system for display on an electronic device for a user.
